(19) United States
(12) Patent Application Publication
(10) Pub. No.: US 2023/0194801 A1
(43) Pub. Date: Jun. 22, 2023

(54) OPTICAL DEVICE THAT IS FORMED ON OPTICAL INTEGRATED CIRCUIT CHIP

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 18/071,994

(22) Filed: Nov. 30, 2022

(30) Foreign Application Priority Data
Dec. 20, 2021 (JP) 2021-206007

(51) Int. Cl. G02B 6/42; G02B 6/43

(52) U.S. Cl. CPC G02B 6/4206; G02B 6/43

(57) ABSTRACT

An optical device is formed on an optical integrated circuit (IC) chip. The optical device includes: an optical circuit, a first grating coupler, a second grating coupler, a first 1×2 coupler, and a second 1×2 coupler. The first 1×2 coupler is equipped with a first optical port provided at a single-port end and a second optical port and a third optical port provided at a two-port end. The second 1×2 coupler is equipped with a fourth optical port provided at a single-port end and a fifth optical port and a sixth optical port provided at a two-port end. The first grating coupler is coupled to the first optical port. The second optical port is coupled to the optical circuit. The third optical port is coupled to the fourth optical port. The fifth optical port is coupled to the second grating coupler.

### CROSS-REFERENCE TO RELATED APPLICATION

This application is based upon and claims the benefit of priority of the prior Japanese Patent Application No. 2021-206007, filed on Dec. 20, 2021, the entire contents of which are incorporated herein by reference.

### FIELD

The embodiments discussed herein are related to an optical device including an optical circuit formed on an optical IC chip.

### BACKGROUND

FIG. 1 illustrates an example of a method for testing an optical device. In this example, the optical device includes an optical circuit 11. For example, the optical circuit 11 may include an optical receiver. Alternatively, the optical circuit 11 may include an optical receiver and an optical transmitter. In this situation, the optical transmitter includes an optical modulator. The optical circuit 11 is formed on an optical IC chip 10. Meanwhile, an optical waveguide 12 is formed on the surface of the optical IC chip 10. The optical waveguide 12 guides input light to the optical circuit 11.

In a test of the optical device, a light source 101 is used. The light source 101 is, for example, a laser light source and outputs an optical signal (or continuous wave light). A polarization controller (PC) 102 controls the polarization of the optical signal output from the light source 101. The optical signal that passes the polarization controller 102 is incident on the optical waveguide 12 via an optical fiber 103. The optical signal is guided to the optical circuit 11 via the optical waveguide 12.

When the optical circuit 11 is an optical receiver, the optical circuit 11 generates an electric signal indicating the input optical signal. It is decided whether the optical circuit 11 is normal based on the electric signal. When the optical circuit 11 is an optical modulator, continuous wave light is input to the optical circuit 11 via the optical waveguide 12, and a drive signal (not illustrated) is also supplied to the optical circuit 11. Then, a modulated optical signal corresponding to the drive signal is generated. It is decided whether the optical circuit 11 is normal based on the modulated optical signal.

After optical IC chips 10 are cut off from a wafer, the testing method illustrated in FIG. 1 is performed for each optical IC chip 10. In this situation, the optical fiber 103 needs to be aligned with an end face of the optical waveguide 12 formed on the optical IC chip 10. Hence, a long time will be required for testing the optical device.

FIG. 2 illustrates another example of a method for testing the optical device. In the method depicted in FIG. 2, before each optical IC chip is cut off from the wafer, a test of the optical device is performed on the wafer. In order to perform the test of the optical device on the wafer, light needs to be guided to the optical circuit 11 by emitting the light to the surface of the wafer. Thus, grating couplers are formed in the vicinity of the optical circuit 11.

In the example depicted in FIG. 2, the optical IC chip 10 includes a device region 10a for forming the optical circuit 11, and also includes a coupler region 10b for forming grating couplers (GC) 21 and 22. In the coupler region 10b, the grating coupler 21 is coupled to a 1×2 coupler 25 via an optical waveguide 23. The 1×2 coupler 25 includes one optical port P1 and a pair of optical ports P2 and P3. The optical waveguide 23 is coupled to the optical port P1 of the 1×2 coupler 25. The optical port P2 is coupled to the optical circuit 11 via the optical waveguide 12. The optical port P3 is coupled to the grating coupler 22 via an optical waveguide 24.

When testing the optical device, test light output from the light source 101 is incident on the grating coupler 21 via the polarization controller 102 and the optical fiber 103. Then, the test light is guided to the optical circuit 11 via the optical waveguide 23, the 1×2 coupler 25, and the optical waveguide 12. Subsequently, operations of the optical circuit 11 are checked using the test light. In this situation, the power of the test light input to the optical circuit 11 is preferably measured. Accordingly, the test light is split using the 1×2 coupler 25, and split light is guided to the grating coupler 22 via an optical waveguide 24. Light emitted from the grating coupler 22 is guided to an optical power meter 105 via the optical fiber 104. The power of the test light input to the optical circuit 11 is calculated based on optical power measured by the optical power meter 105.

A dicing line is configured or defined between the device region 10a and the coupler region 10b. When cutting off the optical IC chip 10 from the wafer, the coupler region 10b is cut off from the device region 10a. Note that configurations have been proposed in which the characteristics of an optical device are measured on a wafer before an optical IC chip is cut off from the wafer (e.g., Japanese Laid-open Patent Publication No. 2020-021015 and U.S. Pat. No. 10,145,758).

According to the configuration depicted in FIG. 2, each of the optical IC chips can be tested on the wafer. In this test, the step of disposing end portions of optical fibers in the vicinity of grating couplers is easy in comparison with the step of aligning an optical fiber with an end face of an optical waveguide. Thus the method depicted in FIG. 2 can have a shortened test time in comparison with the method depicted in FIG. 1.

However, a loss in the grating couplers needs to be considered to calculate the power of test light input to the optical circuit 11 in the configuration depicted in FIG. 2. Thus, the test light guided from the grating coupler 21 to the optical circuit 11 is split by the 1×2 coupler 25 and guided to the optical power meter 105. The power of the test light input to the optical circuit 11 is calculated based on the optical power measured by the optical power meter 105.

This calculation is based on an assumption that a loss caused by the 1×2 coupler 25 is known. The loss caused by the 1×2 coupler 25 should be about 3 dB but would actually exhibit variations. Thus, when a loss in the grating coupler is estimated using a value of loss in a typical 1×2 coupler, the power of test light input to the optical circuit 11 may not be accurately measured. Meanwhile, providing the optical IC chip 10 with a dedicated circuit for measuring a loss in the 1×2 coupler will decrease the space efficiency of the wafer and lead to the need to perform a step of measuring a loss in the 1×2 coupler.

### SUMMARY

According to an aspect of the embodiments, an optical device is formed on an optical integrated circuit (IC) chip. The optical device includes: an optical circuit; a first grating coupler; a second grating coupler; a first 1×2 coupler that is equipped with a first optical port provided at a single-port end and a second optical port and a third optical port provided at a two-port end; and a second 1×2 coupler that is equipped with a fourth optical port provided at a single-port end and a fifth optical port and a sixth optical port provided at a two-port end. The first grating coupler is coupled to the first optical port. The second optical port is coupled to the optical circuit. The third optical port is coupled to the fourth optical port. The fifth optical port is coupled to the second grating coupler.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a method for testing an optical device;

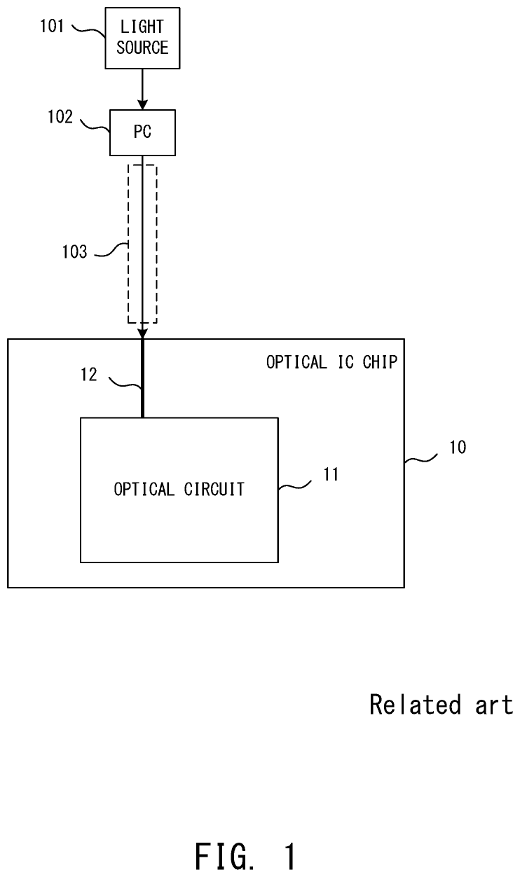

FIG. 2 illustrates another example of a method for testing the optical device;

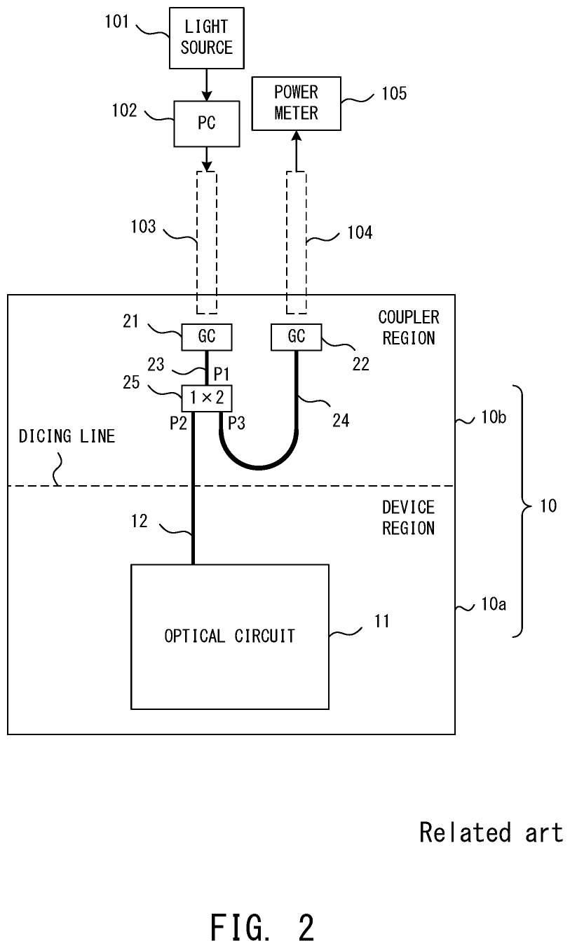

FIG. 3 illustrates an example of a wafer on which a plurality of optical IC chips are formed;

FIG. 4 illustrates an example of an optical device implemented on an optical IC chip;

FIGS. 5A and 5B are explanatory diagrams for radiation from, and incidence on, grating couplers;

FIG. 6 illustrates an example of an optical device in accordance with embodiments of the present invention;

FIG. 7 illustrates a first variation of the optical device in accordance with embodiments of the present invention;

FIGS. 8A and 8B illustrate examples of an optical terminator;

FIG. 9 illustrates a second variation of the optical device in accordance with embodiments of the present invention;

FIG. 10 illustrates a third variation of the optical device in accordance with embodiments of the present invention;

FIG. 11 illustrates a fourth variation of the optical device in accordance with embodiments of the present invention;

FIG. 12 illustrates a fifth variation of the optical device in accordance with embodiments of the present invention; and

FIG. 13 illustrates an example of an optical transceiver module in accordance with embodiments of the present invention.

### DESCRIPTION OF EMBODIMENTS

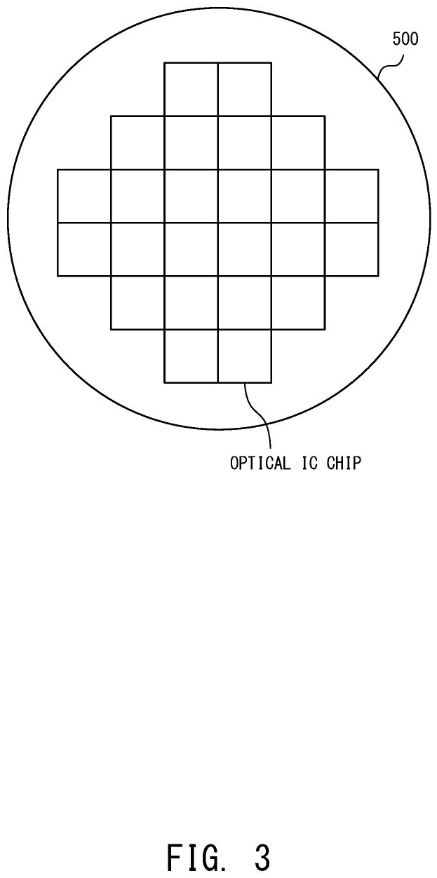

FIG. 3 illustrates an example of a wafer on which a plurality of optical IC chips are formed. A plurality of optical IC chips are formed on a surface of a wafer 500. In the example depicted in FIG. 3, 24 optical IC chips are formed on the wafer 500. For example, each of the optical IC chips may form an optical device including an optical receiver and an optical modulator (i.e., an optical transceiver). Hence, a plurality of optical devices can be produced from the wafer 500 by dicing. However, a test of each of the optical devices is performed on the wafer 500 before the optical IC chips are cut off from the wafer 500.

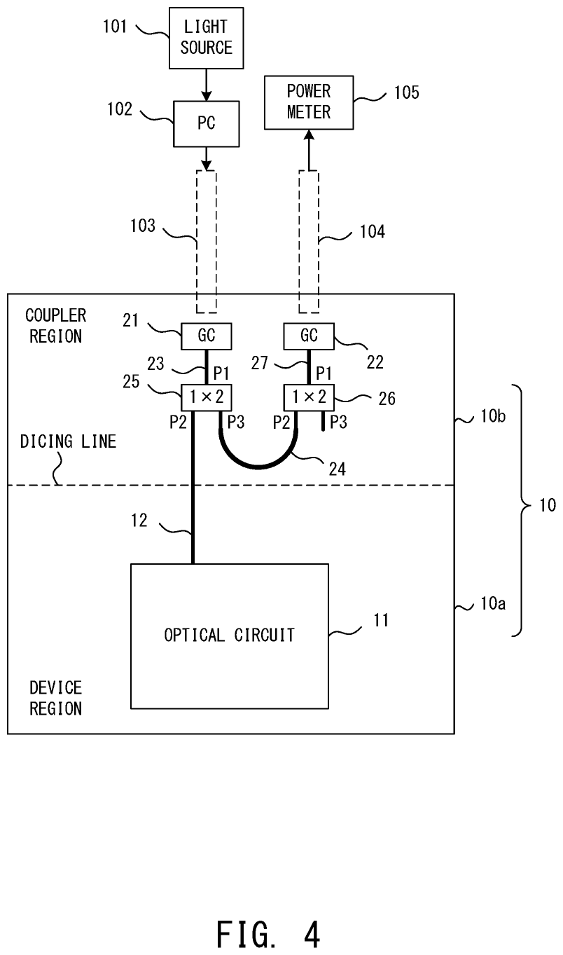

FIG. 4 illustrates an example of an optical device implemented on an optical IC chip. In this example, an optical IC chip 10 is formed from a device region 10a and a coupler region 10b. A dicing line is configured between the device region 10a and the coupler region 10b.

An optical circuit 11 is formed in the device region 10a. As described above, the optical circuit 11 includes an optical receiver and/or an optical modulator.

An optical waveguide 12 is coupled to the optical circuit 11. The optical waveguide 12 can guide input light to the optical circuit 11. The optical waveguide 12 extends beyond the dicing line and reaches the coupler region 10b. Note that other circuits or elements that are not depicted in FIG. 4 may be formed in the device region 10a.

Grating couplers (GC) 21 and 22 and 1×2 couplers 25 and 26 are formed in the coupler region 10b. Each of the 1×2 couplers 25 and 26 is equipped with an optical port P1 and a pair of optical ports P2 and P3. Light input via the optical port P1 is split and guided to the optical ports P2 and P3. Light input via the optical port P2 is guided to the optical port P1. Likewise, light input via the optical port P3 is guided to the optical port P1. In this configuration, the path from the optical port P1 toward the optical port P2 and the path from the optical port P2 toward the optical port P1 are substantially the same in terms of the loss between the optical ports P1 and P2. The path from the optical port P1 toward the optical port P3 and the path from the optical port P3 toward the optical port P1 are also substantially the same in terms of the loss between the optical ports P1 and P3.

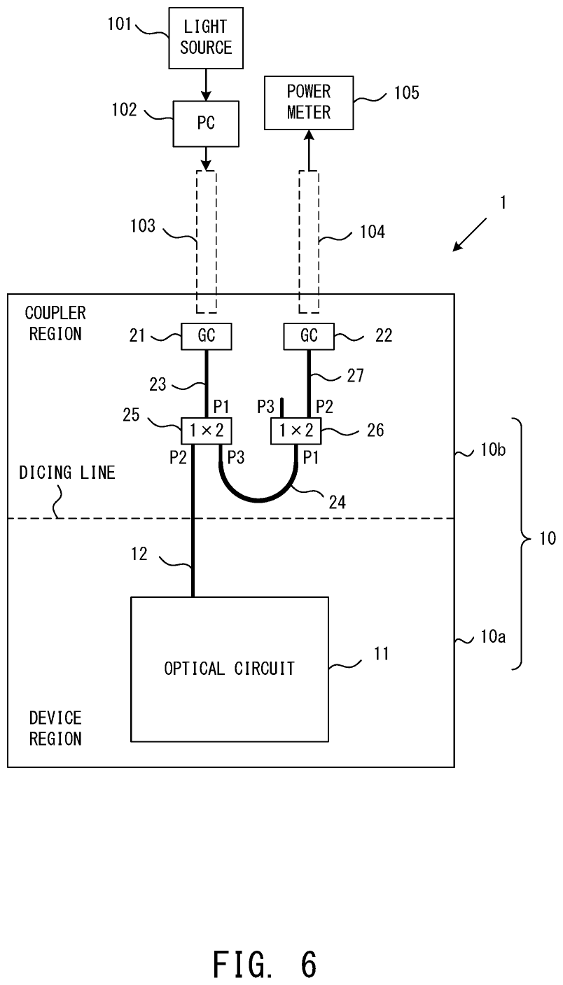

Other circuits or elements that are not depicted in FIG. 4 may be formed in the coupler region 10b. In the illustration of FIG. 4 (and FIGS. 6-7 and FIGS. 9-11 and the like described hereinafter), the coupler region 10b is relatively large for better visibility in comparison with the device region 10a. However, it is actually preferable that the coupler region 10b be sufficiently small in comparison with the device region 10a.

The grating coupler 21 is coupled to the optical port P1 of the 1×2 coupler 25 via an optical waveguide 23. The optical waveguide 12 is coupled to the optical port P2 of the 1×2 coupler 25. Thus, the optical port P2 of the 1×2 coupler 25 is coupled to the optical circuit 11 via the optical waveguide 12. The optical port P3 of the 1×2 coupler 25 is coupled to the optical port P2 of the 1×2 coupler 26 via an optical waveguide 24. The optical port P1 of the 1×2 coupler 26 is coupled to the grating coupler 22 via an optical waveguide 27. In this example, the optical port P3 of the 1×2 coupler 26 is not used.

A test system for testing the optical circuit 11 includes a light source 101, a polarization controller (PC) 102, and an optical power meter 105. The light source 101 outputs an optical signal (or continuous wave light). The polarization controller 102 controls the polarization of the optical signal output from the light source 101. For example, in TE polarization measurement, the polarization controller 102 may control the polarization of an optical signal output from the light source 101, such that TE waves are input to the optical circuit 11. The optical signal output from the polarization controller 102 is guided to the grating coupler 21 via an optical fiber 103. The optical fiber 104 guides light emitted from the grating coupler 22 to the optical power meter 105. The optical power meter 105 measures the power of the light emitted from the grating coupler 22.

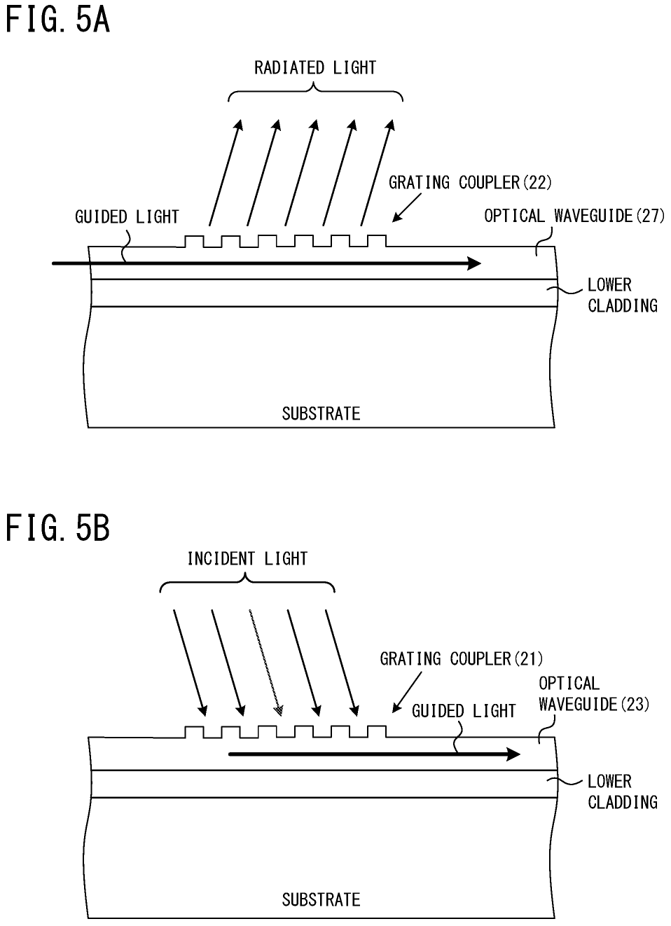

For example, the grating couplers may be formed by providing gratings on faces of the waveguides. As depicted in FIG. 5A, when guided light propagating through an optical waveguide passes a grating coupler, a portion of the guided light are radiated in a specified direction with respect to the substrate. A direction in which the portion of guided light are radiated by the grating coupler may hereinafter be referred to as a “diffraction direction.” Meanwhile, as depicted in FIG. 5B, when light is incident on a grating coupler at a specified angle with respect to the substrate, a portion of the incident light will propagate through an optical waveguide.

Accordingly, disposing an end face of the optical fiber 103 in the vicinity of the grating coupler 21 allows light to be incident on the optical waveguide 23 via the optical fiber 103. Disposing an end face of the optical fiber 104 in the vicinity of the grating coupler 22 allows light propagating through the optical waveguide 27 to be received by the optical fiber 104. Thus, the grating couplers 21 and 22 can optically couple, on the surface of the optical IC chip 10, the optical fibers 103 and 104 respectively to the optical waveguides 23 and 27.

The grating couplers 21 and 22 are preferably formed such that the diffraction directions of these couplers are the same. In this situation, the optical fibers 103 and 104 may be implemented by optical fiber arrays.

When testing the optical circuit 11, test light output from the light source 101 is incident on the grating coupler 21 via the polarization controller 102 and the optical fiber 103. Then, the test light is guided to the optical circuit 11 via the optical waveguide 23, the 1×2 coupler 25, and the optical waveguide 12. Subsequently, operations of the optical circuit 11 are checked using the test light.

A portion of the test light is split by the 1×2 coupler 25 and output from the optical port P3. Split light (that is, the portion of the test light) output from the optical port P3 of the 1×2 coupler 25 may hereinafter be referred to as “reference light.” In this example, the 1×2 coupler 25 has a splitting ratio of, for example, 1:1. In this situation, the power of test light output from the optical port P2 of the 1×2 coupler 25 is substantially the same as the power of reference light output from the optical port P3 of the 1×2 coupler 25.

The reference light output from the optical port P3 of the 1×2 coupler 25 is guided to the optical port P2 of the 1×2 coupler 26 via the optical waveguide 24. Then, the reference light is output from the optical port P1 of the 1×2 coupler 26 and guided to the grating coupler 22 via the optical waveguide 27. Furthermore, the reference light emitted from the grating coupler 22 is guided to the optical power meter 105 via the optical fiber 104. According to this configuration, the power of the test light input to the optical circuit 11 is calculated based on the power of the reference light measured by the optical power meter 105.

In the test described above, the following formula (1) is satisfied, where P_LD is the power of output light of the light source 101, and P_ref is the power of reference light measured by the optical power meter 105.

P_{LD}−Lin−GC21−CPL25−CPL26−GC22−Lout=P_ref (1)

Assume that P_LD is known. Lin indicates a loss caused by the polarization controller 102 and the optical fiber 103 and can be measured in advance. GC21 indicates a loss caused by the grating coupler 21. CPL25 indicates a loss caused by the 1×2 coupler 25. CPL26 indicates a loss caused by the 1×2 coupler 26. GC22 indicates a loss caused by the grating coupler 22. Lout indicates a loss caused by the optical fiber 104 and can be measured in advance.

Accordingly, a coupling/splitting loss L (=GC21+CPL25+CPL26+GC22) can be obtained by measuring the power P_ref of reference light using the optical power meter 105. Thus, the sum of losses caused by the grating coupler 21, the 1×2 coupler 25, the 1×2 coupler 26, and the grating coupler 22 is obtained. Assume that: the losses caused by the grating couplers 21 and 22 are the same each other; and the losses caused by the 1×2 couplers 25 and 26 are the same each other. In this situation, the coupling/splitting loss L indicates the sum of the losses caused by the two grating couplers and the losses caused by the two 1×2 couplers. Hence, a sum of the loss caused by one grating coupler and the loss caused by one 1×2 coupler can be calculated by dividing the coupling/splitting loss L by “2”. In the configuration depicted in FIG. 4, the sum of the loss caused by the grating coupler 21 and the loss caused by the 1×2 coupler 25 may be calculated.

As described above, the sum of the loss caused by the grating coupler 21 and the loss caused by the 1×2 coupler 25 can be calculated by measuring the power P_ref of reference light by using the optical power meter 105. Hence, this value can be used to perform calibration so that the power of test light input to the optical circuit 11 can be accurately estimated.

However, in the configuration depicted in FIG. 4, measurement accuracy may decrease due to reflection by the 1×2 couplers. As depicted in FIG. 4, each of the 1×2 couplers is equipped with an optical port (P1) and a pair of optical ports (P2, P3). In the following, an input/output end of the 1×2 coupler at which one optical port (P1) is provided may be referred to as a “single-port end (or a single-port face or single-port side),” and an input/output end at which the pair of optical ports (P2, P3) is provided may be referred to as a “two-port end (or a two-port face or two-port side).”

When the two-port end is seen from the single-port end, the two optical paths (that is, a path from P1 to P2 and a path from P1 to P3) are symmetrical. Thus, reflection is small when light is input via the optical port (i.e., optical port P1) provided at the single-port end. For example, reflection will be sufficiently small when test light is input to the optical port P1 of the 1×2 coupler 25.

However, when the single-port end is seen from the two-port end, the optical paths (that is, a path from P2 to P1 and a path from P3 to P1) are asymmetrical. Thus, reflection occurs when light is input via an optical port (e.g., optical port P2) provided at the two-port end. For example, large reflection may occur when reference light is input to the optical port P2 of the 1×2 coupler 26. When reflection occurs at the 1×2 coupler 26, the reflection light will be guided to the light source 101 via the 1×2 coupler 25, the grating coupler 21, and the optical fiber 103. As a result, operations (e.g., laser oscillation operation) of the light source 101 become unstable, thereby decreasing the measurement accuracy.

FIG. 6 illustrates an example of an optical device in accordance with embodiments of the present invention. An optical device 1 in accordance with embodiments of the present invention is substantially the same as the configuration depicted in FIG. 4. In particular, the optical circuit 11 is formed in the device region 10a. The grating couplers (GCs) 21 and 22 and the 1×2 couplers 25 and 26 are formed in the coupler region 10b.

However, in the optical device 1, the optical port P3 of the 1×2 coupler 25 that outputs reference light is coupled to the optical port P1 of the 1×2 coupler 26 via the optical waveguide 24, unlike in the configuration depicted in FIG. 4. The optical port P2 of the 1×2 coupler 26 is coupled to the grating coupler 22 via the optical waveguide 27.

Accordingly, when test light is input to the optical device 1, reference light will be input to the optical port P1 provided at the single-port end of the 1×2 coupler 26. Then, the reference light is output from each of the optical ports P2 and P3 provided at the two-port end of the 1×2 coupler 26. Furthermore, the reference light output from the optical port P2 is guided to the optical power meter 105 via the optical waveguide 27, the grating coupler 22, and the optical fiber 104.

FIGS. 4 and 6 are substantially the same in terms of the method for calculating the power of test light input to the optical circuit 11. In particular, also in the optical device 1, the sum of a loss caused by the grating coupler 21 and a loss caused by the 1×2 coupler 25 is calculated using formula (1). Accordingly, the power of test light input to the optical circuit 11 can be accurately estimated by measuring the power P ref of the reference light by using the optical power meter 105. Note that it is assumed that, in the 1×2 coupler 26, the loss in light input to the optical port P2 and output from the optical port P1 (FIG. 4) is the same as the loss in light input to the optical port P1 and output from the optical port P2 (FIG. 6).

As described above, in the optical device 1 depicted in FIG. 6, reference light output from the 1×2 coupler 25 is input to the optical port (i.e., P1) provided at the single-port end of the 1×2 coupler 26. Hence, reflection of the reference light will be small in comparison with the configuration depicted in FIG. 4. As a result, operations (e.g., laser oscillation operation) of the light source 101 are stable, thereby increasing the measurement accuracy.

In addition, the test of the optical circuit 11 is performed before each optical IC chip 10 is cut off from the wafer. After the test is finished, the optical IC chip 10 is cut off from the wafer. Furthermore, the coupler region 10b is cut off from the optical IC chip 10. Cutting off the coupler region 10b from the optical IC chip 10 causes a leading end of the optical waveguide 12 to be positioned at an edge of the device region 10a. Thus, when the optical device 1 is implemented in an optical module, an optical fiber will be held to be aligned with the leading end of the optical waveguide 12.

In the description referring to FIG. 6, the optical device 1 is formed from the device region 10a and the coupler region 10b. However, an optical device 1 may indicate an optical IC chip 10 obtained after a coupler region 10b is cut off.

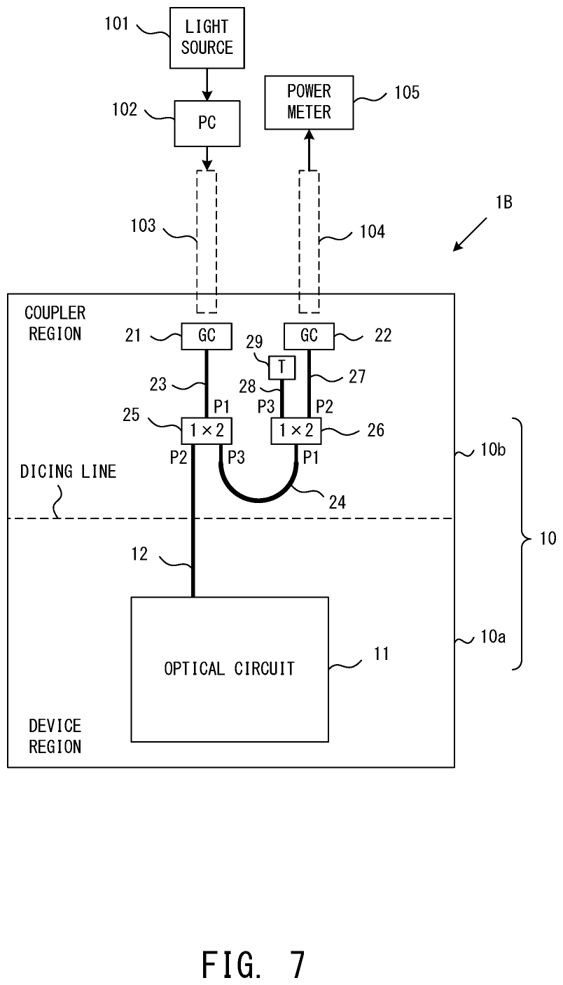

FIG. 7 illustrates a first variation of the optical device in accordance with embodiments of the present invention. In the optical device 1 depicted in FIG. 6, the other optical port (i.e., P3) of the pair of optical ports provided at the two-port end of the 1×2 coupler 26 is open. By contrast, in an optical device 1B in accordance with the first variation, the optical port P3 of the 1×2 coupler 26 is, as depicted in FIG. 7, connected to an optical terminator (T) 29 via an optical waveguide 28. Thus, split light (i.e., light output from the optical port P3 of the 1×2 coupler 26) of the reference light is absorbed or radiated at the optical terminator 29. Hence, reflection of the reference light will be further suppressed in comparison with the configuration depicted in FIG. 6.

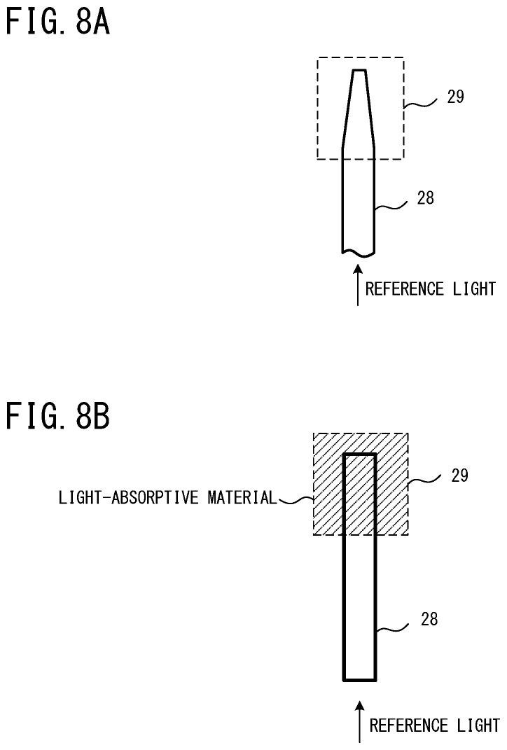

FIG. 8A illustrates an example of the optical terminator 29 implemented in the optical device 1B depicted in FIG. 7. In this example, the optical terminator 29 is implemented by a tapered waveguide. In particular, the optical terminator 29 is implemented by gradually decreasing the width of the optical waveguide coupled to the optical port P3 of the 1×2 coupler 26 toward the leading end. According to this configuration, light output from the optical port P3 of the 1×2 coupler 26 is radiated from the leading end of the tapered waveguide. Thus, reflection is suppressed when reference light is input to the optical port P1 of the 1×2 coupler 26.

FIG. 8B illustrates another example of the optical terminator 29 implemented in the optical device 1B depicted in FIG. 7. In this example, the optical terminator 29 is implemented by a light-absorptive material. Specifically, the optical terminator 29 is implemented by providing a light-absorptive material in a specified region including the leading end of the optical waveguide coupled to the optical port P3 of the 1×2 coupler 26. For example, the light-absorptive material may be a metal such as aluminum or gold, a semiconductor thin film, or a silicon material doped with impurities such as boron. According to this configuration, light output from the optical port P3 of the 1×2 coupler 26 is absorbed at the leading end of the optical waveguide 28. Thus, reflection is suppressed when reference light is input to the optical port P1 of the 1×2 coupler 26.

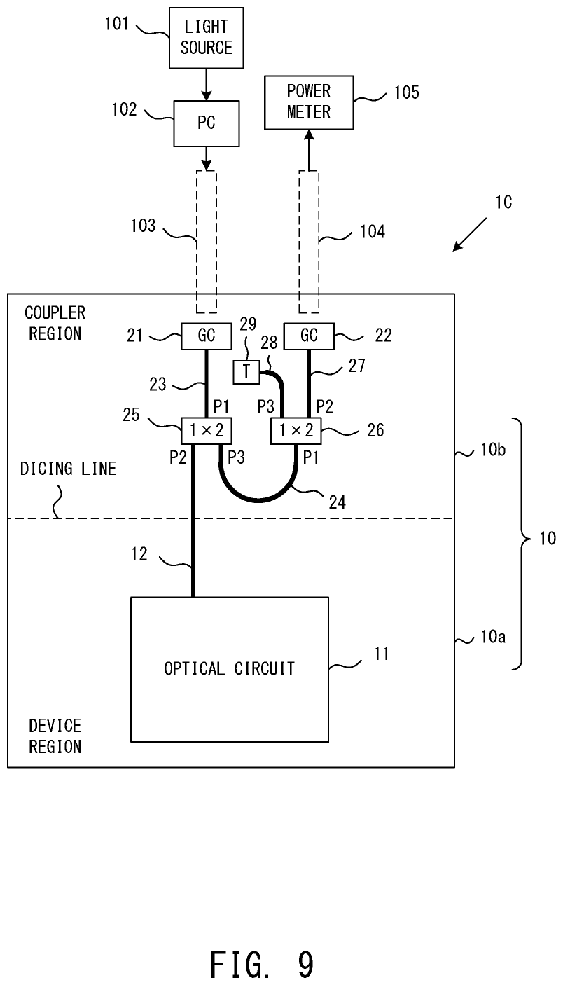

FIG. 9 illustrates a second variation of the optical device in accordance with embodiments of the present invention. In the first variation depicted in FIG. 7, the optical waveguide 28 coupled to the optical port P3 of the 1×2 coupler 26 extends toward the grating couplers 21 and 22. Thus, if the optical terminator 29 is implemented by the tapered waveguide depicted in FIG. 8A, light radiated from the leading end of the tapered waveguide may be recombined at the grating couplers 21 and 22.

In the optical device 10 in accordance with the second variation, in order to alleviate the above problem, the optical waveguide 28 coupled to the optical port P3 of the 1×2 coupler 26 is formed to extend in a direction in which neither of the grating couplers 21 and 22 is provided. In the example depicted in FIG. 9, the optical waveguide 28 is curved to form an angle of about 90 degrees. According to this configuration, when the optical terminator 29 is implemented by the tapered waveguide depicted in FIG. 8A, the leading end of the tapered waveguide will face in a direction in which neither of the grating couplers 21 and 22 are provided. Thus, light radiated from the leading end of the tapered waveguide will not be recombined at the grating couplers 21 and 22. When the optical terminator 29 is implemented by the light-absorptive material depicted in FIG. 8B, residual light that leaks from the optical waveguide will not be recombined at the grating couplers 21 and 22. Thus, light can be prevented from unintentionally being guided to the light source 101 and/or the optical power meter 105, thereby increasing the measurement accuracy.

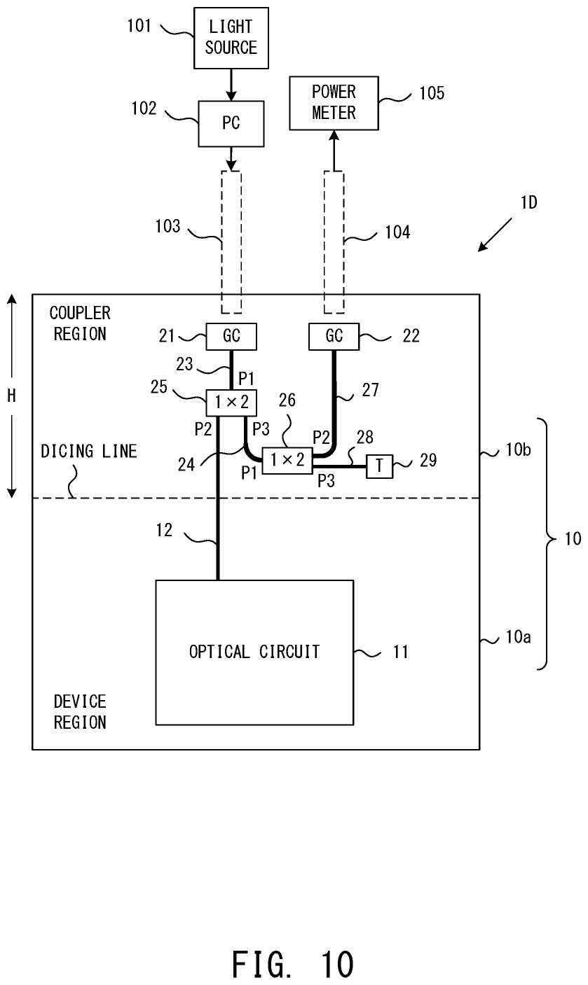

FIG. 10 illustrates a third variation of the optical device in accordance with embodiments of the present invention. In the first variation depicted in FIG. 7 and the second variation depicted in FIG. 9, the optical terminator 29 is provided in the region between the grating couplers 21 and 22 and the 1×2 couplers 25 and 26. Thus, in the first and second variations, a space to provide the optical terminator 29 is needed between the grating couplers 21 and 22 and the 1×2 couplers 25 and 26, so the coupler region 10b may be large-sized.

In an optical device 1D in accordance with the third variation, the orientations of the 1×2 couplers 25 and 26 are different from each other. In the example depicted in FIG. 10, the 1×2 coupler 25 is disposed in a direction from the grating coupler 21 toward the optical circuit 11. By contrast, the 1×2 coupler 26 is disposed in a direction orthogonal to the direction from the grating coupler 21 toward the optical circuit 11. Hence, the optical terminator 29 can be provided in an open region different from the region between the grating couplers 21 and 22 and the 1×2 couplers 25 and 26. In this example, the optical terminator 29 is provided in a region in the vicinity of the dicing line. Accordingly, in comparison with the configurations depicted in FIGS. 7 and 9, this configuration allows the area of the region between the grating couplers 21 and 22 and the 1×2 couplers 25 and 26 to be decreased, so that the coupler region 10b may be configured with a small height H. Thus, optical IC chips 10 can be small-sized, thereby making the wafer area-efficient.

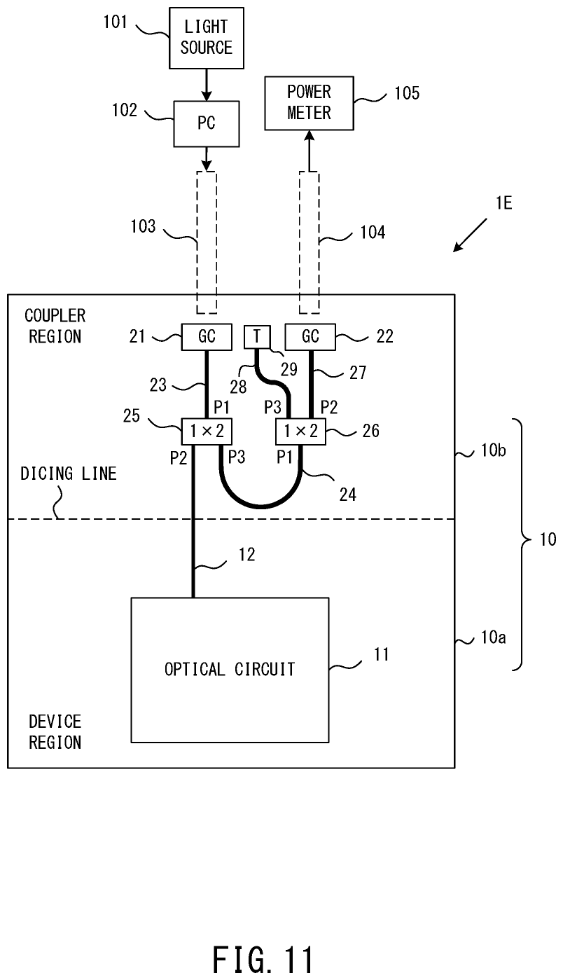

FIG. 11 illustrates a fourth variation of the optical device in accordance with embodiments of the present invention. In an optical device 1E in accordance with the fourth variation, the optical terminator 29 is provided between the grating couplers 21 and 22. For example, the spacing between the grating couplers 21 and 22 may be designed based on the pitch of the optical fiber arrays. For example, the spacing between the grating couplers 21 and 22 may be about 127 μm. The size of each of the grating couplers 21 and 22 is about 20 μm. Hence, in this situation, the optical terminator 29 can be formed between the grating couplers 21 and 22. The optical terminator 29 is coupled to the optical port P3 of the 1×2 coupler 26 via the optical waveguide 28.

According to this configuration, even when the optical terminator 29 is implemented by the tapered waveguide depicted in FIG. 8A, light radiated from the leading end of the tapered waveguide will not be recombined at the grating couplers 21 and 22. Moreover, the coupler region 10b can be small-sized.

In the examples depicted in FIGS. 6-7 and 9-11, two grating couplers are provided on the optical IC chip 10. However, the present invention is not limited to this configuration. That is, three or more grating couplers may be provided on the optical IC chip 10 as necessary. For example, in the case of performing a test for measuring the quality of an optical signal generated by the optical circuit 11, a grating coupler for emitting the optical signal generated by the optical circuit 11 may be provided in addition to the grating couplers 21 and 22.

When three or more grating couplers are provided on the optical IC chip 10, the grating couplers preferably have the same diffraction direction. In addition, the grating couplers are preferably disposed in a straight line at equal spacings. The spacings at which the plurality of grating couplers are disposed are equal to the pitch of the optical fiber arrays. In this way, the efficiency of testing optical IC chips on the wafer can be enhanced.

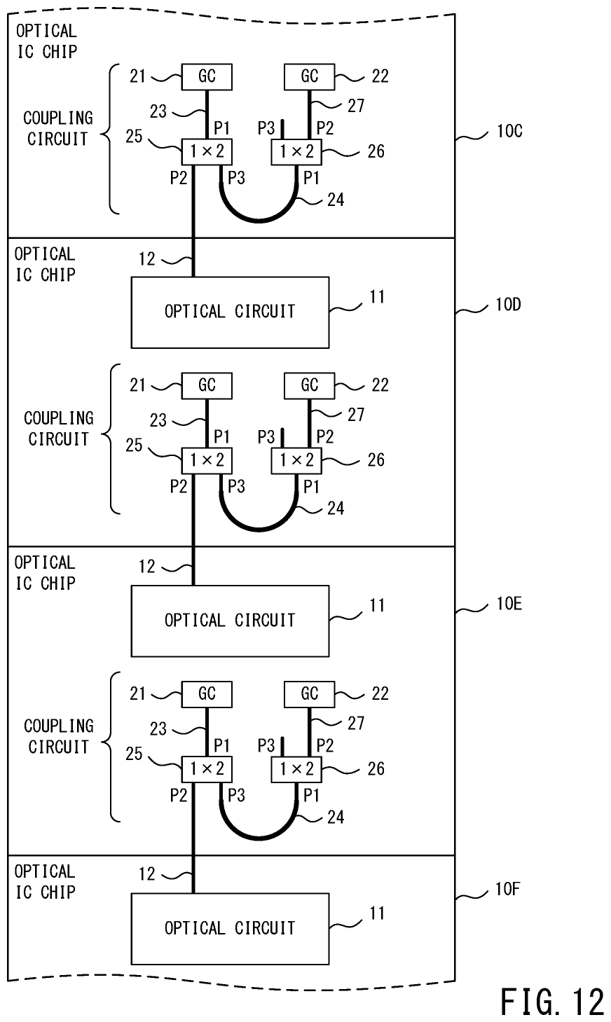

FIG. 12 illustrates a fifth variation of the optical device in accordance with embodiments of the present invention. FIG. 12 depicts a plurality of optical IC chips 10C-10F formed on the wafer. Note that only portions of the optical IC chips 10C and 10F are depicted.

As in the configurations depicted in FIGS. 6-7 and 9-11, an optical circuit 11, grating couplers 21 and 22, and 1×2 couplers 25 and 26 are formed on each optical IC chip. Optical waveguides 23, 24, and 27 for coupling the elements are also formed. In addition, an optical terminator 29 may be provided on each optical IC chip.

However, in the fifth variation, the optical circuit 11 formed on each optical IC chip is connected to a coupling circuit formed on an adjacent optical IC chip. The coupling circuit includes grating couplers 21 and 22 and 1×2 couplers 25 and 26. For example, the optical circuit 11 formed on the optical IC chip 10D may be connected to the coupling circuit formed on the optical IC chip 10C, and the optical circuit 11 formed on the optical IC chip 10E may be connected to the coupling circuit formed on the optical IC chip 10D. Each optical circuit 11 is coupled to a corresponding coupling circuit by an optical waveguide 12.

When testing an optical circuit 11, the coupling circuit formed on an adjacent optical IC chip is used. When, for example, testing the optical circuit 11 of the optical IC chip 10D, optical fibers 103 and 104 are disposed in the vicinity of the grating couplers 21 and 22 formed on the optical IC chip 10C. Test light incident via the grating coupler 21 is guided to the optical circuit 11 via the 1×2 coupler 25. In this situation, light split by the 1×2 coupler 25 (i.e., reference light) is guided to the power meter 105 via the 1×2 coupler 26 and the grating coupler 22 on the optical IC chip 10C.

After the test of each optical circuit 11 is finished, each optical IC chip is cut off from the wafer. As a result, a plurality of optical devices are provided.

In this regard, in the configurations depicted in FIGS. 6-7 and FIGS. 9-11, the coupler region is cut off from the optical IC chip. By contrast, in the fifth variation depicted in FIG. 12, the grating couplers 21 and 22 and the 1×2 couplers 25 and 26 may remain in each IC chip. Meanwhile, when cutting off an optical IC chip from the wafer, an optical waveguide 12 coupled to the optical circuit 11 is cut. Thus, the leading end of the optical waveguide 12 will be positioned at an edge of the optical IC chip. Accordingly, when the optical device is implemented in an optical module, an optical fiber will be held to be aligned with the leading end of the optical waveguide 12.

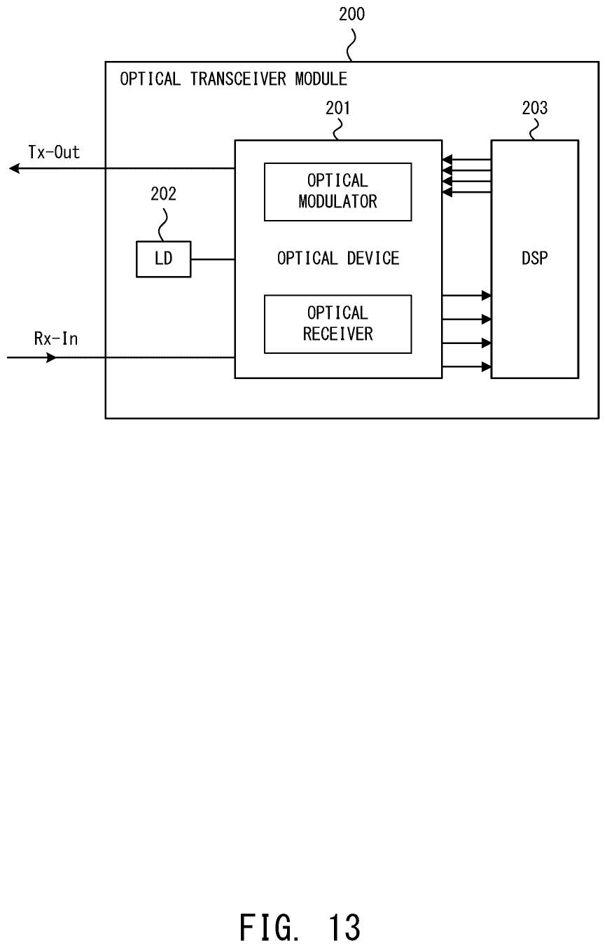

FIG. 13 illustrates an example of an optical transceiver module in accordance with embodiments of the present invention. An optical transceiver module 200 includes an optical device 201, a light source (LD) 202, and a digital signal processor (DSP) 203.

The optical device 201 is implemented by any of the optical IC chips depicted in FIG. 4, FIGS. 6-7, and FIGS. 9-12. Thus, the optical device 201 includes the optical circuit 11. For example, the optical circuit 11 may include an optical modulator and an optical receiver. The light source 202 generates continuous wave light. The continuous wave light is supplied to the optical modulator. When the optical receiver is a coherent receiver, the continuous wave light is also supplied to the optical receiver. A received optical signal (Rx_In) is guided to the optical receiver. A modulated optical signal (Tx_Out) generated by the optical modulator is output to an optical fiber transmission line. The digital signal processor 203 generates a data signal to be used by the optical device 201 so as to generate a modulated optical signal. The digital signal processor 203 processes an electric signal indicating an optical signal received by the optical device 201.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An optical device that is formed on an optical integrated circuit (IC) chip, the optical device comprising:
an optical circuit;
a first grating coupler;
a second grating coupler;
a first 1×2 coupler that is equipped with a first optical port provided at a single-port end and a second optical port and a third optical port provided at a two-port end; and
a second 1×2 coupler that is equipped with a fourth optical port provided at a single-port end and a fifth optical port and a sixth optical port provided at a two-port end, wherein
the first grating coupler is coupled to the first optical port,
the second optical port is coupled to the optical circuit,
the third optical port is coupled to the fourth optical port, and
the fifth optical port is coupled to the second grating coupler.

2. The optical device according to claim 1, wherein
the optical circuit is formed in a device region of the optical IC chip,
the first grating coupler, the second grating coupler, the first 1×2 coupler, and the second 1×2 coupler are formed in a coupler region of the optical IC chip, and
a dicing line is configured between the device region and the coupler region.

3. The optical device according to claim 1, further comprising:
an optical terminator coupled to the sixth optical port.

4. The optical device according to claim 3, wherein
the optical terminator includes
an optical waveguide that is coupled to the sixth optical port, and
a tapered waveguide that radiates light propagating through the optical waveguide.

5. The optical device according to claim 4, wherein
a leading end of the tapered waveguide faces in a direction in which neither the first grating coupler nor the second grating coupler is formed.

6. The optical device according to claim 3, wherein
the optical terminator includes
an optical waveguide that is coupled to the sixth optical port, and
a light-absorptive material that absorbs light propagating through the optical waveguide.

7. The optical device according to claim 3, wherein
the second 1×2 coupler is disposed such that the two-port end of the second 1×2 coupler faces in a direction in which neither the first grating coupler nor the second grating coupler is formed.

8. The optical device according to claim 3, wherein
the optical terminator is disposed in a region between the first grating coupler and the second grating coupler.

9. A wafer on which a plurality of optical IC chips are formed, wherein
each of the optical IC chips includes
an optical circuit,
a first grating coupler,
a second grating coupler,
a first 1×2 coupler that is equipped with a first optical port provided at a single-port end and a second optical port and a third optical port provided at a two-port end, and
a second 1×2 coupler that is equipped with a fourth optical port provided at a single-port end and a fifth optical port and a sixth optical port provided at a two-port end,
on each of the optical IC chips,
the first grating coupler is coupled to the first optical port,
the third optical port is coupled to the fourth optical port, and
the fifth optical port is coupled to the second grating coupler,
the optical circuit formed on a first optical IC chip among the plurality of optical IC chips is coupled to the second optical port of the first 1×2 coupler formed on a second optical IC chip adjacent to the first optical IC chip, and
the second optical port of the first 1×2 coupler formed on the first optical IC chip is coupled to the optical circuit formed on a third optical IC chip adjacent to the first optical IC chip.
